(19) United States
(12) Patent Application Publication
(10) Pub. No.: US 2026/0179420 A1
(43) Pub. Date: Jun. 25, 2026

(54) Vehicle Rear-Seat Trunk Access Locking System

(71) Applicant: Phillip Emory, Gainesville, GA (US)

(72) Inventor: Phillip Emory, Gainesville, GA (US)

(21) Appl. No.: 19/303,823

(22) Filed: Aug. 19, 2025

Related U.S. Application Data
(60) Provisional application No. 63/736,015, filed on Dec. 19, 2024.

(51) Int. Cl. G07C 9/00; B60R 25/04; B60R 25/24; B60R 25/25

(52) U.S. Cl. CPC G07C 9/00944; B60R 25/04; B60R 25/24; B60R 25/25; G07C 9/00309; G07C 2009/00793; G07C 2209/63

(57) ABSTRACT

A vehicle rear-seat trunk-access locking system is provided. The system is designed to prevent unauthorized trunk access via folding down an existing rear seat of a vehicle. The system is comprised of an electronic latch mechanism that engages with a striker plate mounted to the seat structure. The latch comprises a solenoid actuator that drives a locking pin into engagement, governed by an electronic control unit receiving input from user interfaces and sensors. A multi-factor authorization sequence involving ignition activation, proximity token verification, and a manual or digital release command is required to trigger latch disengagement, with optional biometric verification for enhanced security. The system also comprises a concealed handle assembly with a spring-loaded locking plate and mechanical linkage to the latch for authorized manual override, ensuring both electronic and mechanical tamper resistance.

### CROSS-REFERENCE TO RELATED APPLICATION

The present application claims priority to, and the benefit of, U.S. Provisional Application No. 63/736,015, which was filed on Dec. 19, 2024, and is incorporated herein by reference in its entirety.

### FIELD OF THE INVENTION

The present invention relates generally to the field of vehicle security. More specifically, the present invention relates to a system designed to prevent unauthorized trunk access by folding down an existing rear seat of a vehicle. Accordingly, the present disclosure makes specific reference thereto. Nonetheless, it is to be appreciated that aspects of the present invention are also equally applicable to other like applications, devices, and methods of manufacture.

### BACKGROUND

In many modern vehicles, the rear seats are designed to fold down, enabling access to the trunk area from within the passenger cabin. While this feature is convenient for transporting long or bulky items, it inadvertently introduces a security vulnerability. Individuals attempting unauthorized entry into a vehicle may exploit this fold-down functionality to bypass the external trunk lock. By gaining access to the interior of the vehicle, intruders can fold down the rear seats and reach the contents of the trunk without triggering typical security measures associated with external trunk access. This method of intrusion is particularly concerning because it can be executed with minimal visible damage to the exterior of the vehicle, complicating forensic detection and insurance claims. Conventional vehicle security systems focus primarily on doors and external trunk latches, often overlooking interior-based threats. Additionally, no standard mechanism currently exists to selectively restrict or electronically lock rear seat fold-down functions based on user authorization or ignition status. Vehicle owners are therefore left without a method to secure their trunks from internal compromise. This presents a persistent challenge in automotive security systems and necessitates the development of a more advanced, integrated approach to trunk access control.

Therefore, there exists a long-felt need in the art for a vehicle rear-seat trunk-access locking system that electronically secures the fold-down mechanism of rear vehicle seats to prevent unauthorized trunk access. There also exists a long-felt need in the art for a vehicle rear-seat trunk-access locking system that integrates with existing vehicle electrical systems and user authentication protocols for seamless operation. Moreover, there exists a long-felt need in the art for a vehicle rear-seat trunk-access locking system that enables trunk security to be governed by multi-factor authentication methods to enhance overall vehicle safety.

The subject matter disclosed and claimed herein, in one embodiment thereof, comprises a vehicle rear-seat trunk-access locking system. The system is designed to prevent unauthorized trunk access via folding down an existing rear seat of a vehicle. The system is comprised of an electronic latch mechanism that engages with a striker plate mounted to the seat structure. The latch comprises a solenoid actuator that drives a locking pin into engagement, governed by an electronic control unit receiving input from user interfaces and sensors. A multi-factor authorization sequence involving ignition activation, proximity token verification, and a manual or digital release command is required to trigger latch disengagement, with optional biometric verification for enhanced security. The system also comprises a concealed handle assembly with a spring-loaded locking plate and mechanical linkage to the latch for authorized manual override, ensuring both electronic and mechanical tamper resistance. A method of use comprises sequential authorization steps culminating in electronic or mechanical release of the seat lock, enabling controlled access to the vehicle trunk.

In this manner, the vehicle rear-seat trunk-access locking system of the present invention accomplishes all the foregoing objectives and provides a system that directly addresses the vulnerabilities associated with interior-based trunk access by introducing an electronically controlled latch that restricts seat folding unless specific authorization criteria are met. The system accomplishes this by incorporating a smart electronic latch mechanism that engages a striker plate on the seat and remains locked unless released by a solenoid actuator controlled via an integrated electronic interrupt switch. Further, the system is fully compatible with a vehicle's electrical infrastructure, including CAN bus integration and microcontroller-based logic for secure communication and actuation. In this manner, the vehicle rear-seat trunk-access locking system accomplishes all the foregoing objectives by preventing unauthorized fold-down of rear seats, ensuring controlled trunk access, and significantly enhancing the security posture of the vehicle interior.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle rear-seat trunk-access locking system. The system is configured to prevent unauthorized access to a vehicle trunk area through the fold-down rear seat. The system is comprised of multiple subsystems integrated with the vehicle's electrical, mechanical, and user-access infrastructure to ensure secure and intuitive operation.

More specifically, the system is comprised of a smart electronic latch configured to automatically engage a striker plate of a vehicle seat, serving as the primary locking mechanism. The latch may be mounted to the seat or vehicle structure using at least one mounting fastener. The latch is comprised of at least one solenoid actuator that drives a locking pin into or around the striker plate to form a mechanical interlock. The latch is connected to the vehicle's power system through at least one insulated wire routed via a dedicated conduit or existing wiring channels. A control signal from an electronic control unit or microcontroller may drive the solenoid actuator, based on input from various sensors and user commands. The latch may include a return spring to retract the pin when de-energized, and a position sensor to confirm engagement.

The system is further comprised of an electronic interrupt switch that controls the operational logic of the latch. This switch is embedded in the vehicle's user interface and connected via a wiring harness that may integrate with the ignition circuit or CAN bus. The switch may include a micro-relay or solid-state relay to manage high-current circuits.

An auxiliary button module may be included for authorized manual unlock commands, forming part of a multi-factor authorization sequence. This sequence may require activation of the ignition system, detection of a proximity token such as a key fob or authenticated mobile device, and activation of an authorized release button, which may be tactile or digital. When all conditions are met, the latch actuator is energized, retracting the locking pin from the striker plate to permit seat movement. An optional biometric module may provide additional authentication via fingerprint, facial, or iris recognition.

To increase concealment and tamper resistance, the system may include a concealed handle assembly integrated into the rear surface of the seatback. This assembly may feature a recessed handle covered by a spring-loaded plate, locked by a secondary solenoid or electromagnetic mechanism. The handle is mechanically linked to the latch and becomes operable only when electronic authorization is confirmed.

The invention is further comprised of a method for using the system. The method includes providing a system comprised of the smart electronic latch, solenoid actuator, locking pin, electronic interrupt switch, wiring harness, auxiliary button module, multi-factor authorization sequence, proximity token, authorized release button, biometric module, and concealed handle assembly. Upon vehicle entry, the user initiates the ignition, enabling proximity token verification. The user then activates the release button, and if applicable, completes biometric authentication. Upon successful authorization, the interrupt switch enables power to the actuator, retracting the locking pin and allowing the seat to fold. For manual override, the user accesses the concealed handle assembly once unlocked and pulls the handle to mechanically disengage the latch and access the trunk area.

Accordingly, the vehicle rear-seat trunk-access locking system of the present invention is particularly advantageous as it provides a system that directly addresses the vulnerabilities associated with interior-based trunk access by introducing an electronically controlled latch that restricts seat folding unless specific authorization criteria are met. The system accomplishes this by incorporating a smart electronic latch mechanism that engages a striker plate on the seat and remains locked unless released by a solenoid actuator controlled via an integrated electronic interrupt switch. Further, the system is fully compatible with a vehicle's electrical infrastructure, including CAN bus integration and microcontroller-based logic for secure communication and actuation. In this manner, the vehicle rear-seat trunk-access locking system accomplishes all the foregoing objectives by preventing unauthorized fold-down of rear seats, ensuring controlled trunk access, and significantly enhancing the security posture of the vehicle interior.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of components of one potential embodiment of a vehicle rear-seat trunk-access locking system of the present invention in accordance with the disclosed architecture;

FIG. 2 illustrates a schematic view of components of a seat of one potential embodiment of a vehicle rear-seat trunk-access locking system of the present invention in accordance with the disclosed architecture; and

FIG. 3 illustrates a flowchart of a method of using one potential embodiment of a vehicle rear-seat trunk-access locking system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle rear-seat trunk-access locking system that electronically secures the fold-down mechanism of rear vehicle seats to prevent unauthorized trunk access. There also exists a long-felt need in the art for a vehicle rear-seat trunk-access locking system that integrates with existing vehicle electrical systems and user authentication protocols for seamless operation. Moreover, there exists a long-felt need in the art for a vehicle rear-seat trunk-access locking system that enables trunk security to be governed by multi-factor authentication methods to enhance overall vehicle safety.

The present invention, in one exemplary embodiment, is comprised of a vehicle rear-seat trunk-access locking system. The system is designed to prevent unauthorized access to a vehicle trunk area via the fold-down rear seat. The system is comprised of multiple subsystems integrated with the vehicle's electrical, mechanical, and user-access infrastructure to support secure and intuitive operation.

More specifically, the system is comprised of a smart electronic latch configured to automatically engage a striker plate of a vehicle seat, serving as the primary locking mechanism. The latch may be secured to the seat or vehicle structure using at least one mounting fastener. The latch is further comprised of at least one solenoid actuator that drives a locking pin into or around the striker plate to create a mechanical interlock. The latch is electrically connected to the vehicle's power system through at least one insulated wire, which may be routed through a dedicated conduit or integrated wiring channel. The solenoid actuator may be operated by a control signal from an electronic control unit or microcontroller that responds to sensor data and user input. A return spring may be included to retract the pin when de-energized, along with a position sensor to verify locking engagement.

The system is additionally comprised of an electronic interrupt switch that governs the operational logic of the latch. The switch is embedded in the vehicle's user interface and connected through a wiring harness that may interface with the ignition circuit or CAN bus. The switch may include a micro-relay or solid-state relay to control high-current actuation circuits.

An auxiliary button module may be included to allow authorized users to manually issue unlock commands, forming part of a multi-factor authorization sequence. This sequence may require ignition system activation, detection of a proximity token such as a key fob or authenticated mobile device, and activation of an authorized release button, which may be implemented as a tactile or digital interface. When all required conditions are fulfilled, the actuator is energized to retract the locking pin from the striker plate, enabling movement of the seat. A biometric module may also be integrated to provide additional authentication through fingerprint, facial, or iris recognition.

To improve concealment and resistance to tampering, the system may be comprised of a concealed handle assembly integrated into the rear surface of the seatback. The assembly may include a recessed handle covered by a spring-loaded plate, which is retained in a locked state by a secondary solenoid or electromagnetic mechanism. The handle is mechanically linked to the latch and becomes operable only after successful electronic authorization.

The invention is further comprised of a method for using the system. The method includes providing a system comprised of the smart electronic latch, solenoid actuator, locking pin, electronic interrupt switch, wiring harness, auxiliary button module, multi-factor authorization sequence, proximity token, authorized release button, biometric module, and concealed handle assembly. Upon vehicle entry, the user initiates the ignition to begin proximity token verification. The user then activates the release button and, if required, completes biometric authentication. Once all required criteria are met, the interrupt switch enables current to the actuator, retracting the locking pin and allowing the seat to fold. For manual override, the user may access the concealed handle assembly once it is unlocked and pull the handle to mechanically disengage the latch and access the trunk area.

As a result, the vehicle rear-seat trunk-access locking system of the present invention provides a solution that addresses vulnerabilities associated with interior-based trunk access by implementing an electronically controlled latch that prevents seat folding without proper authorization. The system achieves this by employing a smart latch mechanism that engages a striker plate on the seat and remains locked unless released by a solenoid actuator governed by an integrated electronic interrupt switch. Furthermore, the system is compatible with the vehicle's electrical architecture, including CAN bus integration and microcontroller-based logic for secure communication and control. As a result, the vehicle rear-seat trunk-access locking system effectively prevents unauthorized seat folding, enables controlled trunk access, and enhances the overall security of the vehicle interior.

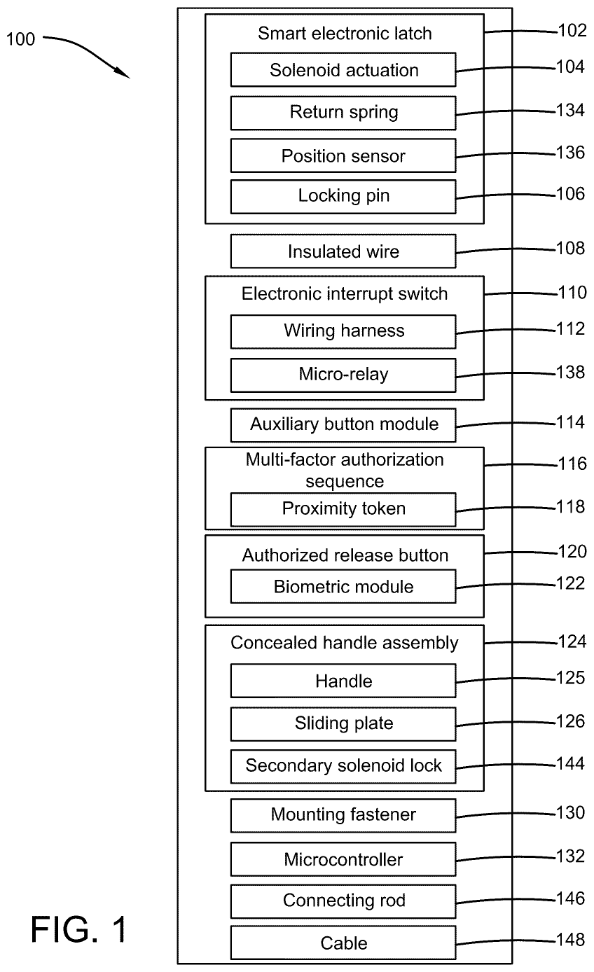

Referring initially to the drawings, FIG. 1 illustrates a schematic view of components of one potential embodiment of a vehicle rear-seat trunk-access locking system 100 of the present invention in accordance with the disclosed architecture. The system 100 is configured to prevent unauthorized access to a vehicle trunk area via the existing fold-down rear seat of a vehicle. The system 100 is comprised of multiple interdependent subsystems engineered for seamless integration with a vehicle's electrical, mechanical, and user-access control infrastructure to ensure secure, responsive, and intuitive operation.

More specifically, the system 100 is comprised of a smart electronic latch 102 that is configured to automatically engage the striker plate 10 of a vehicle seat 12, which serves as the locking point for the system 100. The latch 102 may be secured to the seat 12 itself and/or any other body structure of the vehicle via at least one mounting fastener 130. The mounting fastener 130 may be comprised of threaded bolts, rivets, locking pins, or other attachment mechanisms suitable for automotive-grade installations. The mounting fastener 130 may be installed through one or more integrated mounting brackets or flanges on the housing of the latch 102 to ensure vibration-resistant and secure attachment during normal vehicle operation.

The smart electronic latch 102 may be comprised of at least one solenoid actuator 104 that drives at least one locking pin 106 into, through, around, etc., the striker plate 10, thereby establishing a secure mechanical interlock between the latch 102 and the plate 10. The latch 102 is preferably in electrical communication with the vehicle's existing power system through at least one insulated wire 108, which may be routed through a dedicated conduit or integrated into existing wiring channels.

The solenoid actuator 104 may be driven by a control signal from an electronic control unit (ECU) or microcontroller 132, which interprets input from various sensors and user commands to determine latch actuation status. The latch 102 may also be equipped with a return spring 134 to ensure pin retraction upon de-energization, and a position sensor 136 to verify locking engagement.

The system 100 is further comprised of an electronic interrupt switch 110 configured to govern the operational logic of the latch 102. The switch 110 is embedded within the vehicle's user interface and is comprised of a wiring harness 112 that may be interfaced with the ignition circuit and/or the controller area network (CAN) bus of the vehicle. This architecture permits both OEM and aftermarket compatibility. The switch 110 may also be configured to include a micro-relay or solid-state relay 138 to isolate and control high-current actuation circuits.

In one embodiment, the system 100 is comprised of an auxiliary button module 114, which may be installed in a discreet location within the vehicle cabin. The auxiliary button module 114 enables authorized users to issue manual unlock commands to the latch 102 as part of the multi-factor access protocol. More specifically, access to the trunk via the rear seat fold-down mechanism requires successful completion of a multi-factor authorization sequence 116. The sequence 116 may be comprised of at least one of the following conditions: (a) activation of the vehicle ignition system; (b) detection of a valid proximity token 118, such as, but not limited to, a key fob, encrypted RFID card, or authenticated mobile device via Bluetooth Low Energy (BLE) or Near Field Communication (NFC); and (c) activation of an authorized release button 120, which may be implemented as either a tactile switch, a graphical button on a digital infotainment screen, etc.

When all aforementioned conditions are met, the system 100 signals the latch actuator 104 to energize, thereby retracting the locking pin 106 from the striker plate 10 to permit movement of the seat 12. Optionally, a biometric module 122 may be included to introduce an additional layer of security. The biometric module 122 may be comprised of one or more sensors such as a capacitive fingerprint scanner, an infrared facial recognition camera, or an iris recognition module.

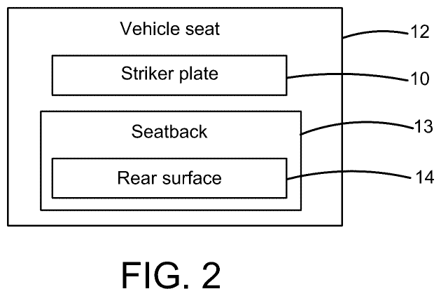

To enhance concealment and tamper resistance, the system 100 may be further comprised of a concealed handle assembly 124 integrated into the rear surface 14 of a seatback 13 of the seat 12 (wherein the components of the same are shown in FIG. 2) that allows the latch 102 to be disengaged from the trunk. The concealed handle assembly 124 may be comprised of a flush-mounted or recessed handle 125 covered by a spring-loaded sliding plate 126. The sliding plate 126 may be retained in a locked position via a secondary solenoid lock 144 and/or electromagnetic latch that only disengages when the system 100 is in an authorized state. The handle 125 may be mechanically linked to the smart electronic latch 102 via a connecting rod 146 or flexible cable 148, and rendered inoperative in the absence of electronic authorization.

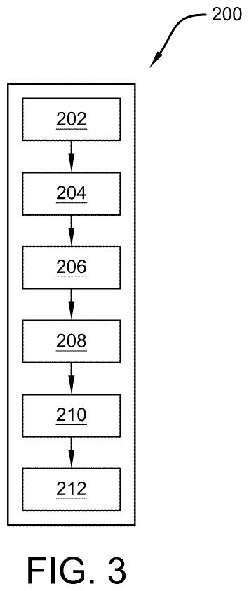

The present invention is also comprised of a method of using 200 the system 100, as seen in FIG. 3. First, a system 100 is provided comprised of a smart electronic latch 102 configured to engage a striker plate 10 of a vehicle seat 12, at least one solenoid actuator 104, a locking pin 106, an electronic interrupt switch 110, a wiring harness 112, an auxiliary button module 114, a multi-factor authorization sequence 116, a proximity token 118, an authorized release button 120, a biometric module 122, and a concealed handle assembly 124 [Step 202]. Then, upon entry into the vehicle, an authorized user activates the vehicle ignition system to initiate the authorization process [Step 204]. The system 100 then may verify the presence of a valid proximity token 118, such as a key fob, RFID card, or mobile device using BLE or NFC communication protocols. Then, the user activates the authorized release button 120, which may be presented as a tactile switch or a digital control within the infotainment system interface [Step 206]. Next, if equipped, the user can additionally authenticate themselves via a biometric module 122 to complete the multi-factor authorization sequence 116 [Step 208]. Then, upon successful validation of all required conditions, the electronic interrupt switch 110 enables power flow to the solenoid actuator 104, which energizes to retract the locking pin 106 from the striker plate 10, thereby allowing the rear seat 12 to be folded down. Next, if manual override access is required, the user may access the concealed handle assembly 124 by sliding open a spring-loaded plate 126, which becomes unlocked only when the system 100 is in an authorized state [Step 210]. Finally, the user pulls the exposed handle 125, which is mechanically linked to the smart electronic latch 102 via a connecting rod 146 or flexible cable 148, thereby disengaging the latch 102 and permitting seat movement to access the trunk area [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle rear-seat trunk-access locking system” and “system” are interchangeable and refer to the vehicle rear-seat trunk-access locking system 100 of the present invention.

Notwithstanding the foregoing, the vehicle rear-seat trunk-access locking system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle rear-seat trunk-access locking system 100 as shown in the FIGS. are for illustrative purposes only, and that many other sizes and shapes of the vehicle rear-seat trunk-access locking system 100 are well within the scope of the present disclosure. Although the dimensions of the vehicle rear-seat trunk-access locking system 100 are important design parameters for user convenience, the vehicle rear-seat trunk-access locking system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle rear-seat trunk-access locking system comprising:
an electronic latch configured to automatically engage a striker plate of a vehicle seat to secure the seat in a locked position;
a solenoid actuator disposed within the latch and configured to drive a locking pin into engagement with the striker plate;
an electronic interrupt switch configured to control an operation of the solenoid actuator; and
a control system configured to activate the solenoid actuator in response to a multi-factor authorization sequence.

2. The vehicle rear-seat trunk-access locking system of claim 1 further comprised of a position sensor that verifies a position of the locking pin relative to the striker plate.

3. The vehicle rear-seat trunk-access locking system of claim 1 further comprised of a mounting fastener that secures the electronic latch to the vehicle seat.

4. The vehicle rear-seat trunk-access locking system of claim 1 further comprised of an electronic control unit or a microcontroller.

5. The vehicle rear-seat trunk-access locking system of claim 4, wherein the electronic control unit or the microcontroller controls the solenoid actuator.

6. The vehicle rear-seat trunk-access locking system of claim 1 further comprised of an electronic interrupt switch.

7. The vehicle rear-seat trunk-access locking system of claim 6, wherein the electronic interrupt switch is further comprised of a micro-relay.

8. The vehicle rear-seat trunk-access locking system of claim 1 further comprised of an auxiliary button module.

9. A vehicle rear-seat trunk-access locking system comprising:
an electronic latch configured to automatically engage a striker plate of a vehicle seat to secure the seat in a locked position;
a solenoid actuator disposed within the latch and configured to drive a locking pin into engagement with the striker plate;
an electronic interrupt switch configured to control an operation of the solenoid actuator;
a control system configured to activate the solenoid actuator in response to a multi-factor authorization sequence; and
a handle assembly comprised of a handle mechanically linked to the electronic latch.

10. The vehicle rear-seat trunk-access locking system of claim 9 further comprised of a position sensor that verifies a position of the locking pin relative to the striker plate.

11. The vehicle rear-seat trunk-access locking system of claim 9 further comprised of a mounting fastener that secures the electronic latch to the vehicle seat.

12. The vehicle rear-seat trunk-access locking system of claim 9 further comprised of an electronic control unit or a microcontroller.

13. The vehicle rear-seat trunk-access locking system of claim 12, wherein the electronic control unit or the microcontroller controls the solenoid actuator.

14. The vehicle rear-seat trunk-access locking system of claim 9 further comprised of an electronic interrupt switch.

15. The vehicle rear-seat trunk-access locking system of claim 14, wherein the electronic interrupt switch is further comprised of a micro-relay.

16. The vehicle rear-seat trunk-access locking system of claim 9 further comprised of an auxiliary button module.

17. A method of using a vehicle rear-seat trunk-access locking system, the method comprising the following steps:
providing a vehicle rear-seat trunk-access locking system comprised of an electronic latch configured to engage a striker plate of a vehicle seat, a solenoid actuator, a locking pin, an electronic interrupt switch, a wiring harness, an auxiliary button module, a multi-factor authorization sequence, a proximity token, an authorized release button, a concealed handle assembly;
activating a vehicle ignition; and
activating the authorized release button.

18. The method of using a vehicle rear-seat trunk-access locking system of claim 17 further comprised of a step of pulling a handle to disengage the electronic latch.

19. The method of using a vehicle rear-seat trunk-access locking system of claim 17, wherein the vehicle rear-seat trunk-access locking system verifies the presence of a valid proximity token.

20. The method of using a vehicle rear-seat trunk-access locking system of claim 17 further comprised of a step of authenticating a user via a biometric module.
